(19) United States
(12) Patent Application Publication
(10) Pub. No.: US 2006/0106641 A1
(43) Pub. Date: May 18, 2006

(54) Portable task management system for healthcare and other uses

(76) Inventors: Ernst Bartsch, Nurnberg (DE); Brian DelMonego, Chester Springs, PA (US); Betty Fink, Bear, DE (US); Gary Grzywacz, Harleysville, PA (US); Stefan Hertel, Furth (DE); Susanne Laumann, Nurnberg (DE); James Pressler, West Chester, PA (US); Ramesh Ramanujam, Erlangen (DE); Donald Taylor, Downingtown, PA (US); Arnold Teres, Broomall, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/114,585

(22) Filed: Apr. 26, 2005

Related U.S. Application Data
(60) Provisional application No. 60/628,419, filed on Nov. 16, 2004.

(51) Int. Cl. G06Q 10/00; G06F 15/02

(52) U.S. Cl. 705/2; 705/9

(57) ABSTRACT

A mobile monitoring and communication system integrates communication services (text, voice, video, and data) with medical information (e.g., patient medical record, patient demographics, reason for procedure, workflow information, etc.) within a radiology department, for example. A medical information system for use with portable processing devices involves a portable processing device including a communication processor for receiving messages from one or more different healthcare workers. An individual message identifies, a task for performance by a particular healthcare worker for a patient, patient and task associated context information and a priority level of the task. A user interface provides data representing at least one display image for display to a user and comprising an overview of tasks of the different healthcare workers including the task for performance by the particular healthcare worker.

This is a non-provisional application of provisional application Ser. No. 60/628,419 by Dr. Ernst Bartsch et al. filed Nov. 16, 2004.

### FIELD OF THE INVENTION

This invention concerns a system and user interface for use together with portable processing devices in task management and related communication.

### BACKGROUND INFORMATION

Existing medical information systems such as a Radiology Information System (RIS) typically require a user performing a procedure for a patient, for example, to go to a stationary PC to view or enter information concerning the patient or procedure. A clinician performing a mobile procedure for a patient typically needs to return to a radiology department to obtain information concerning the patient. Also, if an order for a procedure is received while a clinician is away from the radiology department, it may be a slow and laborious effort (e.g., involving numerous calls, paging etc) to communicate with the clinician and to inform him of the new order. Existing communication systems include, phones, pagers (numeric, alphanumeric and two way messaging) and portable processing devices such as a PDA (personal digital assistant) type device.

Numeric pagers receive and display data identifying a number to call and may include clocks, alarms, alerts and limited preprogrammed alphanumeric messages such as “come to reception”. Alphanumeric pagers allow a caller to leave a text message from phones, the Internet, Live Operator Dispatch, Information Services and Email. Two-Way Messaging pagers support receiving and communication of Email messages. Portable processing devices such as a PulseMobile PDA Medical Software System, for example, comprise a wireless Pocket PC enabling a care provider to access patient data. The PulseMobile, Medical PDA software, offers real-time access to provider schedules, detailed patient history, dictation, prescription management, charge capture and medication data.

However, existing medical information management and communication systems are not integrated and fail to provide efficient timely communication of necessary clinical information, alert messages, scheduled task information and related data supporting clinicians in their duties and supervisory functions. These systems also fail to efficiently prompt responses to communicated alert messages. Communication in hospitals is also impaired because of a lack of real time workflow status information and because multiple communication modes are typically involved in a single communication chain which inhibits propagation of patient medical condition, priority and other context information. Such multiple communication modes include, for example, computerized scheduling, paging and telephoning. A system according to invention principles addresses these deficiencies and related problems.

### SUMMARY OF THE INVENTION

A system manages a workflow (task sequence) of a supervisory healthcare worker (e.g., a supervisory radiologist) and provides a real-time overview of tasks which subordinate healthcare workers (e.g., radiologist residents) are performing and indicates tasks where a second opinion is needed. A medical information system for use with portable processing devices involves a portable processing device including a communication processor for receiving messages from one or more different healthcare workers. An individual message identifies, a task for performance by a particular healthcare worker for a patient, patient and task associated context information and a priority level of the task. A user interface provides data representing at least one display image for display to a user and comprising an overview of tasks of the different healthcare workers including the task for performance by the particular healthcare worker.

### BRIEF DESCRIPTION OF THE DRAWING

FIG. 1 shows interaction and communication between a Supervisory Radiologist, Resident, Referring Physician and Secretary employing a system according to invention principles.

FIG. 2 shows a networked hospital information system including a portable processing device, according to invention principles.

FIG. 3 shows a workflow process employed by a portable processing device system for managing tasks and initiating communication, according to invention principles.

FIG. 4 shows a workflow process for task information routing and priority handling employed by a portable processing device system, according to invention principles.

FIG. 5 shows a flowchart of a process employed by a medical information system using portable processing devices for updating a task schedule of a clinician, according to invention principles.

FIG. 6 shows a flowchart of a process employed by a medical information system using portable processing devices to support supervisory healthcare worker tasks, according to invention principles.

### DETAILED DESCRIPTION OF INVENTION

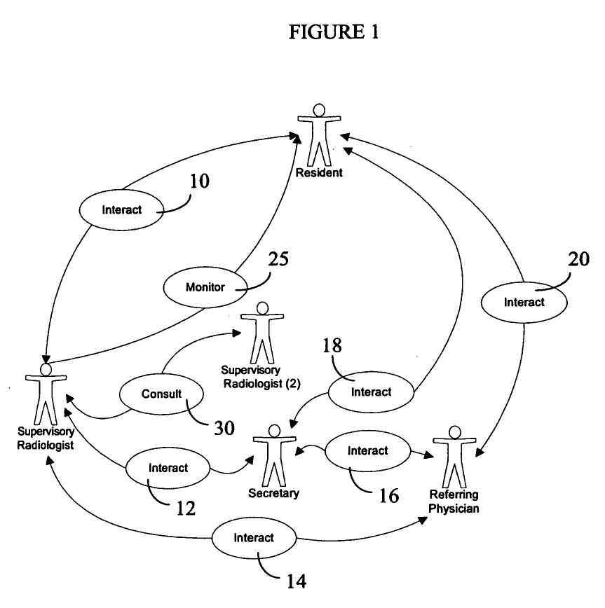

FIG. 1 shows interaction and communication supported by portable processing devices comprising a mobile monitoring and communication system. The mobile monitoring system integrates communication services (text, voice, video, and data) with medical and clinical information (e.g. Electronic Patient Record (EPR) data, patient demographics data, reason for procedure, workflow information, etc.) inside medical centers such as within a radiology department, for example. The system enables a supervisory or other radiologist, for example, to be informed about the status of responsibilities in real time while being en-route in a hospital. The needed information is provided on a portable processing device (e.g., a PDA, palm top, laptop, notebook, mobile phone, watch). The system supports integrated, efficient communication that reduces communication bottlenecks between a resident (i.e. a junior radiologist), supervisory radiologist and referring physician, for example. User interface images presented on a portable processing device are individually configurable. The portable processing device supports a data protection mode to hide predetermined individual user or patient data from being shown to a user without authorization. The system provides a clinician with real time comprehensive task related information including workflow-status, medical, and scheduling information, patient medical record information and requested procedure information, for example, anywhere inside a hospital (or elsewhere) without interrupting a clinicians current duties.

The system provides at least one user interface image presenting an overview of tasks which assigned residents perform for one supervisory radiologist and indicates intelligent data processing of the tasks scheduled for a radiology ward. Although the system is described in the context of a radiology department, this is exemplary only. The system is also applicable in other hospital departments (e.g. cardiology, etc.). A supervising radiologist performing supervisory tasks needs to be up to date concerning responsibilities and items requiring attention, even if traveling. Using the system, a supervisory radiologist receives communication requests from assigned radiologists, needing assistance and guidance at any time. The system also supports communication with administrators, referring physicians, emergency doctors, and fellow radiologists for matters of varying urgency, including obtaining a second opinion concerning a patient anatomical image. A radiologist is typically aware of background information such as average patient waiting time or turnover time of reports, for example.

An executable application as used herein comprises code or machine readable instruction for implementing predetermined functions including those of an operating system, healthcare information system or other information processing system, for example, in response user command or input. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device.

In the FIG. 1 system, bidirectional communications 10-20 support interaction between a Supervisory Radiologist, Resident, Referring Physician and Secretary. Typically a Supervisory Radiologist is contacted for an opinion by either a Resident or a Referring Physician and may also be contacted by a secretary. In exemplary operation, a hospital resident needs help with a patient whilst a Supervisory Radiologist is doing some routine work in the hospital. The resident employs a task management application (in a central server) operating on the mobile monitoring and communication system to indicate that the Supervisory radiologist is to contact the resident regarding tasks to be performed for a patient. The task management application enables communication of a message from a portable processing device of the resident to a portable processing device of the Supervisory Radiologist indicating the Supervisory radiologist is to contact the resident regarding particular identified tasks to be performed for a particular identified patient. The Supervisory radiologist views the request to contact the resident as well as details of the associated patient tasks accessed via a link (e.g., a hyperlink) to the patient electronic patient record. Thereby, the Supervisory radiologist examines the patient medical condition and circumstances and forms an opinion in the case. This enables the Supervisory Radiologist to contact the resident (e.g., by phone or electronically via the portable devices) already having an informed opinion concerning the patient's case. The Supervisory Radiologist also knows the relevant circumstances and is able to focus attention and questions on pertinent details. The Supervisory Radiologist is also able to use the task management application and mobile monitoring and communication system to communicate and consult (30) with another Supervisory radiologist to obtain a further opinion in the case. The Supervisory Radiologist is able to use the task management application to generate an overview of tasks and monitor (25) multiple radiologists and other healthcare workers using a portable processing device. This enables the Supervisory Radiologist to identify where assistance may be needed within the hospital.

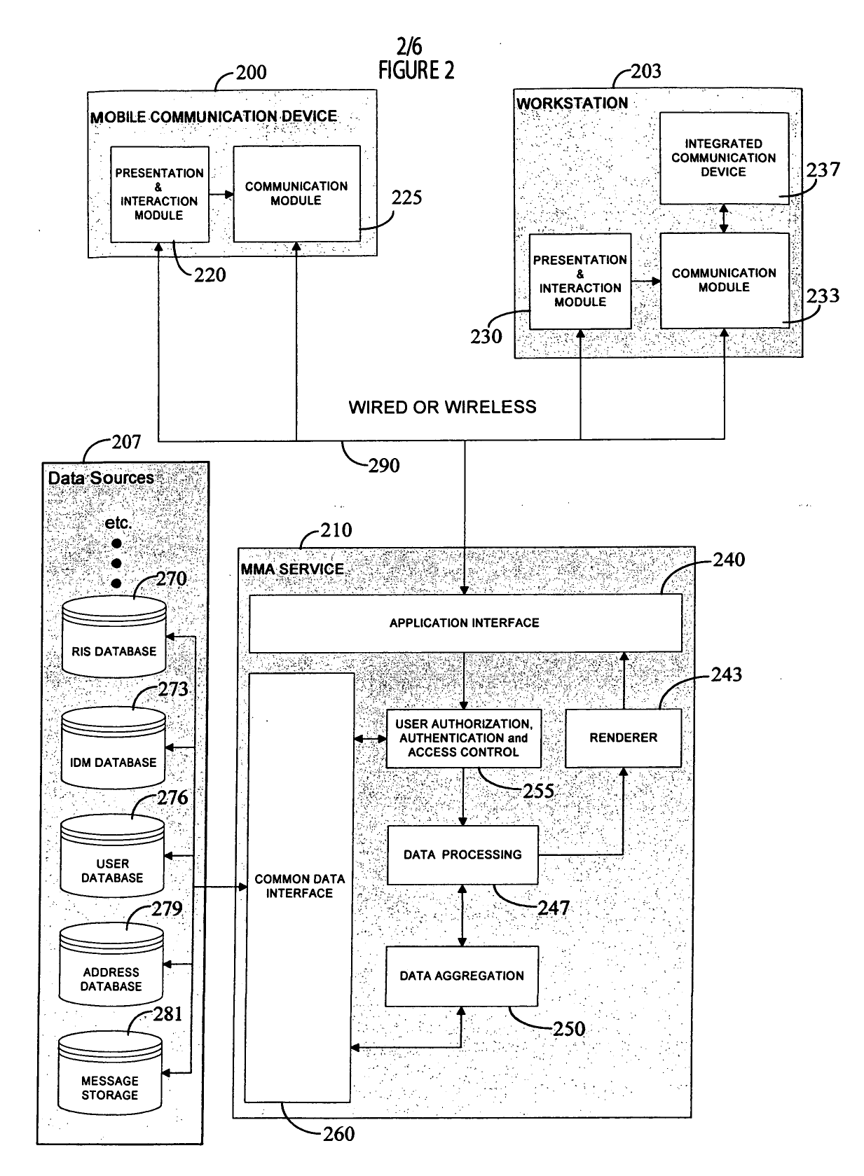

FIG. 2 shows a networked hospital information system including a portable processing device 200 in communication with other portable processing devices (not shown to preserve drawing clarity), workstation 203, and a server application 210 via network 290 such as a wireless radio frequency Local Area Network (LAN). Portable device 200 and workstation 203 support Internet access via network 290 and also support e-mail client software, spreadsheet and database programs, word processing, and various digital storage media. Server application 210 includes application interface 240, common data interface 260, user authorization processor 255, data processing unit 247, data aggregation unit 250 and rendering unit 243. Server application 210 is in communication with data sources 207 comprising one or more distributed repositories 270-281 via common data interface 260. In one embodiment common data interface 260 employs an abstraction layer. Data sources 207 are typically databases but may also be file systems, other server applications, and web services accessed via the Internet or other networks. Data sources 207 include, Radiology Information System (RIS) database 270 incorporating Information available from a Radiology Information System (such as Tasklist and Patient Information). Other data sources 207 include an Image Data Management database 273 containing image related information and associated task data, User Database 276 storing user data, role membership data and user setting information, Address Database 279 storing communication data (such as a mapping from name to IP address or telephone number) and Message Storage repository 281 storing messages.

Data processing unit 247 executes predetermined instructions implementing internal business logic. In response to a user command received from portable device 200 or workstation 203 via network 290, data processing unit 247 identifies data required based on a role of the user indicated by a stored user profile and stored user privilege information in database 276. Data processing unit 247 employs aggregation unit 250 to acquire the identified required data from data sources 207 via common data interface 260. Common data interface 260 provides a single data interface for bidirectional exchange of data between application 210 and data sources 207. Unit 247 merges data from the different databases of data sources 207 and transforms raw database query results into a format readable by rendering unit 243. The database query results are processed by rendering unit 243 to be suitable for display by a presentation device such as within portable device 200 or workstation 203. Application interface 240 provides an interface supporting intra-net and Internet compatible, wired or wireless communication (e.g., using http protocol) with workstation 203 and multiple portable devices such as portable processing device 200. Application interface 240 is connected via wired or wireless Internet connection to communication modules 225 and 233 and presentation and interaction modules 220 and 230, of portable device 200 and workstation 203 respectively. Application interface 240, operating in conjunction with communication modules 225 and 233, support Internet compatible protocols including TCP/IP, Wireless Internet Technology (WLAN, broadband wireless access, etc.) and Voice-over-IP functions.

Presentation and interaction units 220 and 230 provide a user interface (e.g. a web browser) for presenting processed and rendered data for display on portable device 200 and workstation 203 respectively. Interaction units 220 and 230 individually include an input device that permits a user to provide information and an output device that provides a user a display of information. Preferably, the input device is a keyboard and mouse, but also may be a touch screen or a microphone with a voice recognition program, for example. The output device is a display, but also may be a speaker, for example. Workstation 203 includes integrated communication device 207 for establishing an input and output connection for voice data (e.g. soundcard with microphone and headphone or loudspeaker). The output device provides information to the user responsive to the input device receiving information from the user or responsive to other activity. For example, the display presents information responsive to the user entering information via a keyboard. Further, communication modules 225 and 233 of devices 200 and 203, provide bidirectional communication (e.g. voice over IP (VoIP) compatible communication) in response to user command via interaction modules 220 and 230.

Server application 210 employs user authorization and access control unit 255 to validate user authorization, verify user identity and to establish user rights concerning a particular request for information from a user. Unit 255 does this in response to data identifying a user role (such as a Supervisor, Resident, Referrer or Administrator, for example) derived from database 276 based on user identification information received from portable device 200 or workstation 203. Unit 255 also performs a login process for a user. For this purpose, unit 255 employs Internet Security features including https, for example, and Internet compatible authentication and encryption functions. The system advantageously enables a healthcare worker using portable device 200 and fixed location workstation 203, to access patient medical information in an electronic patient record and radiology related data in databases 270 and 273 via bidirectional communication. The system enables real-time update and monitoring of tasks of subordinate healthcare workers such as radiologists by a supervisory healthcare worker such as a supervisory radiologist and gives the supervisory radiologist an overview of tasks of subordinates and an indication of those tasks requiring supervisory assistance. The system enables real time (remote) access and workflow (healthcare worker task sequence) management and control.

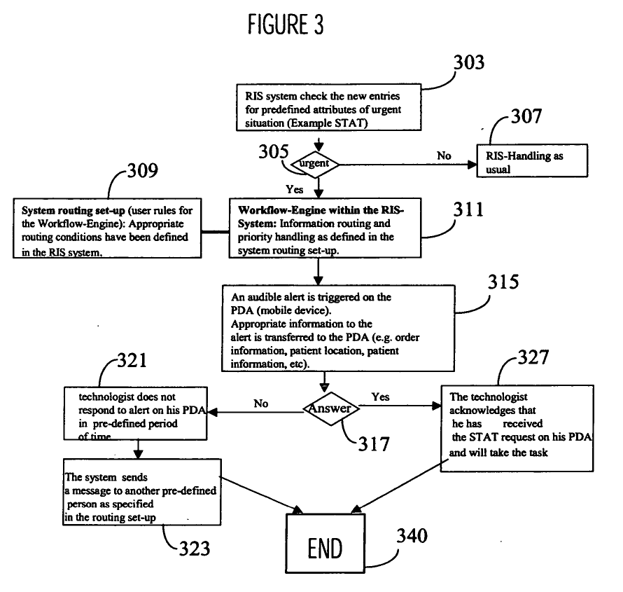

FIG. 3 shows a workflow process employed by a Radiology Information System (RIS) in server application 210 (FIG. 2) communicating via network 290 with portable device 200. Portable processing device 200 uses the FIG. 3 process to manage RIS tasks and initiate communication. In the system, individual portable device 200 includes RIS software and provides real time radiology task information specific to a particular radiologist work assignment whilst the radiologist is in transit thereby facilitating workflow operation and improving productivity and personnel utilization. In step 303, data identifying a STAT (emergency) order is received by the radiology information system in server application 210. The order identifies that immediate attention is required by a particular patient of a particular clinician. A repository (276 FIG. 2) employed by application 210 associates clinician identifiers with corresponding portable devices and associates the particular clinician treating the particular patient with portable device 200. Server application 210 in step 305 examines data identifying orders for radiological services to identify those emergency orders for patients requiring immediate attention. Non-emergency orders are scheduled for normal processing in step 307.

In response to an emergency order being detected in step 305, a workflow engine in the radiology information system in server application 210 in step 311 initiates information communication and routing via network 290 as well as order priority management, based on predetermined configuration data established in step 309. The predetermined configuration data includes a map associating predetermined message routing data with attributes indicating predetermined task or message priority and worker availability, for example. Messages generated by the workflow engine in step 315 initiate an audible alert on portable device 200 alerting the clinician to an emergency order for radiological services to be provided to a particular patient. The messages include parameters that ensure that the sound on portable device 200 is not switched off. The generated messages also automatically transfer information associated with the emergency order concerning the particular patient and facilitating performance of the services. The transferred information includes, order information, patient location, patient medical information, medical device information and any other information the clinician may desire for use in performing the services for the particular patient.

The radiology information system in server application 210 determines in step 317 if an acknowledgement of the received emergency order alert messages is received from the clinician via portable device 200 and network 290. In response to application 210, in step 327, receiving an acknowledgement message indicating the alerted clinician is to perform the radiological services identified in the emergency order, application 210 updates its task scheduling information and the process terminates in step 340. In response to application 210 in step 321 failing to receive an acknowledgement message within a predetermined time window, the workflow engine in step 323 identifies an alternative clinician to be alerted to the emergency order using predetermined clinician availability and qualification information in repository 276. In a similar manner to the communication performed in step 315, the workflow engine in step 323 repeats communication of an alert message and information associated with the emergency order concerning the particular patient to the alternative clinician. This step is repeated a predetermined number of times until an available clinician is found. If an available clinician is not found, an escalation process is initiated and a supervisory clinician informed as well as the originator of the emergency order. Application 210 provides automatic tracking of responses to alert messages and automatically initiates follow-up communications. The process of FIG. 3 terminates in step 340.

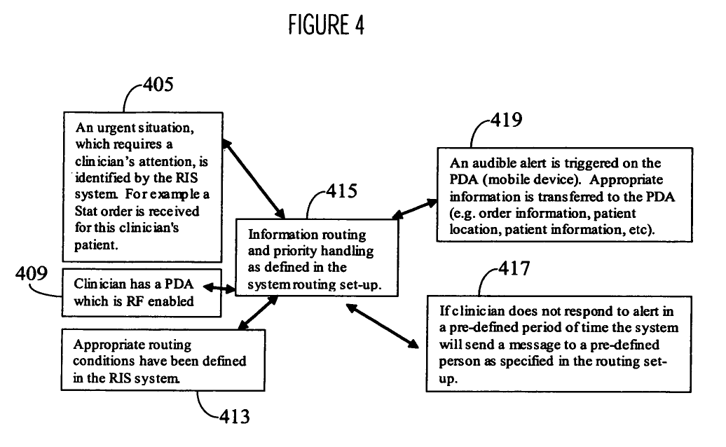

FIG. 4 shows a workflow process for task information routing and priority handling employed by a workflow engine in a Radiology Information System (RIS) in server application 210 (FIG. 2). In response to receiving a message in step 405 identifying emergency services that need to be provided to a particular patient of a particular clinician, the workflow engine in step 409 identifies a portable device of the particular clinician and associated communication link information (including IP address, protocol, data format, portable device network address, for example) from predetermined configuration data. The workflow engine in step 415 initiates information communication and routing from application 210 to the portable device 200 of the particular clinician via network 290 as well as order priority management, based on predetermined configuration data established in step 413.

Messages generated by the workflow engine in step 415 initiate an audible alert on portable device 200 in step 419 alerting the particular clinician to emergency services that need to be provided to the particular patient of the particular clinician. The audible alerts are prioritized to give different sounds for correspondingly different urgency levels of orders. The messages update the particular clinician's displayed work list to include the emergency order at the top. The generated messages also automatically transfer information associated with the emergency order concerning the particular patient. In response to application 210 in step 417 failing to receive an acknowledgement message within a predetermined time window, the workflow engine repeats communication of an alert message and information associated with the emergency order concerning the particular patient to the alternative clinician.

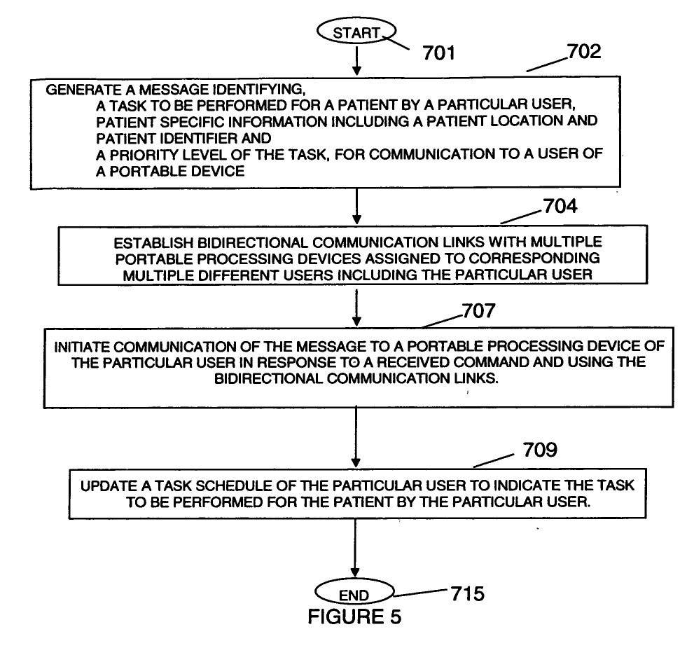

FIG. 5 shows a flowchart of a process employed by a medical information system using portable processing devices for updating a task schedule of a clinician. Server application 210 (FIG. 2) in step 702 following the start at step 701, initiates generation of at least one message to a user of a portable device. The at least one message identifies a task to be performed for a patient by a particular user, patient specific information including a patient location and patient identifier and a priority level of the task. Application 210 in step 704 establishes bidirectional communication with multiple portable processing devices assigned to corresponding multiple different users including the particular user. In step 707, application 210 uses repository 279 (FIG. 2) in automatically initiating communication of the at least one message to a portable processing device of the particular user and assigning the task to the particular user in response to a received command. The message initiates generation of an audible sound on the portable processing device identifying a high priority level task. The at least one message includes information items determined in response to predetermined role dependent information requirements in a profile of the particular user in repository 276 (FIG. 2).

Application 210 in step 709 updates a task schedule of the particular user to indicate the task to be performed for the patient by the particular user. In the event the particular user fails to acknowledge the task assignment message within a predetermined time period, application 210 automatically initiates communication of at least one message assigning the task to an alternative user. For this purpose, application 210 accesses information in repository 276 identifying an alternative user designated to perform the task in the event the particular user fails to acknowledge the task assignment message. The process of FIG. 5 terminates at step 715.

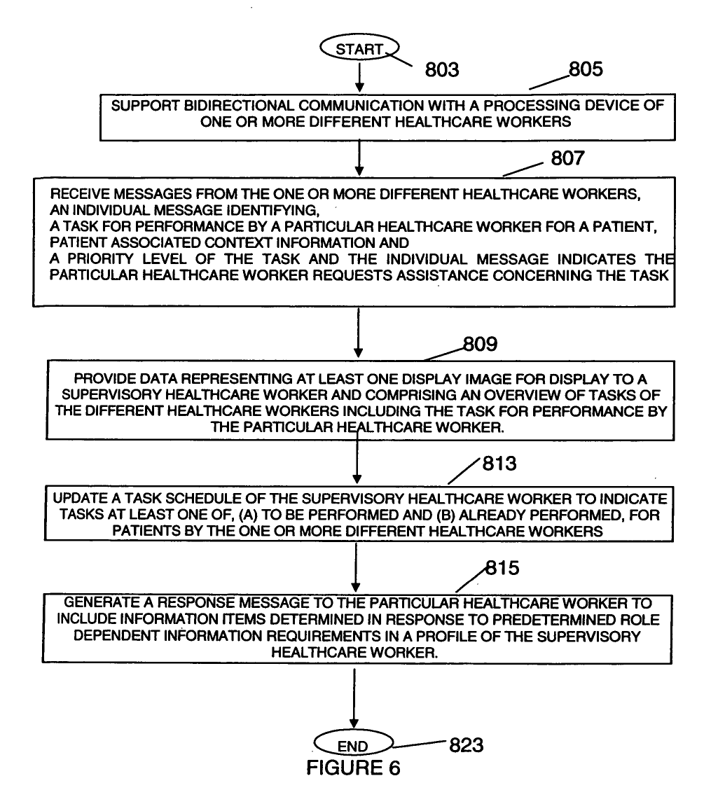

FIG. 6 shows a flowchart of a process employed by a medical information system using portable processing devices to support tasks of a supervisory healthcare worker (e.g., a supervisory radiologist). In step 805 following the start at step 803, application 225 (FIG. 2) in portable processing device 200, supports bidirectional communication with a processing device of one or more different healthcare workers (e.g., radiologists). Application 225 employs an internal or external repository (e.g., repository 279) of data for use in establishing bidirectional communication with multiple portable processing devices assigned to the different healthcare workers. Application 225 in step 807, receives message from a particular healthcare worker of one or more different healthcare workers. An individual message identifies a task for performance by a particular healthcare worker for a patient, as well as patient associated context information and a priority level of the task. The individual message also indicates that the particular healthcare worker requests assistance concerning the task including a second opinion from the supervisory healthcare worker and also requests the supervisory healthcare worker to contact the particular healthcare worker. The patient and task associated context information comprises a patient identifier and patient medical information pertinent to the task, as well as a link (e.g., hyperlink) supporting access to the patient medical information pertinent to the task. The patient and task associated context information also comprises data identifying a location of the patient and data identifying a location where the task is being performed by the particular healthcare worker. The medical information pertinent to the task comprises a section of an electronic patient medical record of the patient and an image or portion of an image produced in response to the task being performed for the patient by the particular healthcare worker. The medical information pertinent to the task may include data identifying a technique used on the last procedure for the patient or what was ordered for the patient.

Application 220 (FIG. 2) in step 809 provides data representing at least one display image for display to a supervisory healthcare worker and comprising an overview of tasks of the different healthcare workers including the task for performance by the particular healthcare worker. The overview of outstanding tasks is updated online via network 290 (FIG. 2) in real time enabling the supervisory healthcare worker to structure and prioritize outstanding tasks. Application 220 in step 813 updates a task schedule of the supervisory healthcare worker to indicate tasks to be performed and already performed, for patients by the one or more different healthcare workers. In step 815, application 225 generates a response message to the particular healthcare worker to include information items determined in response to predetermined role dependent information requirements in a profile of the supervisory healthcare worker in repository 276 (FIG. 2). The process of FIG. 6 terminates at step 823.

The system enables a supervisory radiologist to respond to a request from a radiologist in a prepared manner knowing patient associated context information and the background of a problem or a question. The patient associated context information includes patient name, reason for a procedure, as well as relevant medical images, for example. The system enables a supervisory radiologist to be contacted directly and substantially immediately via portable device 200 in emergency and other situations. In operation, a supervisory radiologist currently monitoring radiologists uses portable device 200 to check task status. In an overview display image on portable device 200, a task element which represents a task currently being performed by a radiologist is updated and highlighted to indicate the supervisory radiologist is requested to contact the radiologist. In addition, a short beep is played on device 200 to indicate to the supervisory radiologist that an update occurred in case the supervisory radiologist is not currently looking at device 200. The supervisory radiologist views the tasks details and reads the text message (e.g. “I don't know if this lung tumor is malignant”). In the message from the radiologist, the supervisory radiologist is provided with a link to an electronic patient record allowing the supervisory radiologist to examine medical circumstances (e.g. “patient has high blood pressure”), enabling a decision to be made in the case.

The supervisory radiologist logs-in to workstation 203 knowing the circumstances and knowing what patient records to open, what image slice position to view to inspect a tumor. The supervisory radiologist determines the tumor is not malignant and calls the radiologist with the second opinion, or sends a message to a portable device 200 of the radiologist providing the second opinion.

The system and processes presented in FIGS. 2-6 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the system of FIG. 2 and processes of FIGS. 3-6 may be implemented in hardware, software or a combination of both. The system is usable wherever a supervisory worker needs to monitor activities of other workers.

What is claimed is:

1. A medical information system for use with portable processing devices, comprising:
a portable processing device including
a communication processor for receiving messages from one or more different healthcare workers, an individual message identifying,
a task for performance by a particular healthcare worker for a patient,
patient and task associated context information and
a priority level of said task;
a user interface for providing data representing at least one display image for display to a user and comprising an overview of tasks of said different healthcare workers including said task for performance by said particular healthcare worker.

2. A system according to claim 1, wherein
said patient and task associated context information comprises a patient identifier and at least one of, (a) patient medical information pertinent to said task and (b) a link supporting access to said patient medical information pertinent to said task.

3. A system according to claim 2, wherein
said medical information pertinent to said task comprises at least one of, (i) a section of an electronic patient medical record of said patient and (b) an image or portion of an image produced in response to said task being performed for said patient by said particular healthcare worker.

4. A system according to claim 2, wherein
said link is a hyperlink.

5. A system according to claim 1, wherein
said patient and task associated context information comprises a patient identifier and at least one of, (a) data identifying a location of said patient and (b) data identifying a location where said task is being performed by said particular healthcare worker.

6. A system according to claim 1, wherein
said communication processor supports bidirectional communication with a processing device of said particular healthcare worker and
said individual message indicates at least one of, (a) said particular healthcare worker requests a second opinion from said user and (b) said user is requested to contact said particular healthcare worker.

7. A system according to claim 6, including
a repository of data for use in establishing bidirectional communication with a plurality of portable processing devices assigned to said different healthcare workers.

8. A system according to claim 6, wherein
said communication processor generates a response message to said particular healthcare worker to include information items determined in response to predetermined role dependent information requirements in a profile of said user.

9. A system according to claim 1, including
an information management processor for updating a task schedule of said user to indicate tasks at least one of, (a) to be performed and (b) already performed, for patients by said one or more different healthcare workers.

10. A system according to claim 1, wherein
said one or more different healthcare workers are radiologists and
said user is a supervising radiologist supervising said radiologists.

11. A medical information system for use with portable processing devices, comprising:
a portable processing device including
a communication processor supporting bidirectional communication with a processing device of one or more different healthcare workers and receiving messages from said one or more different healthcare workers, an individual message identifying,
a task for performance by a particular healthcare worker for a patient,
patient associated context information and
a priority level of said task and said individual message indicates said particular healthcare worker requests assistance concerning said task; and
a user interface for providing data representing at least one display image for display to a supervisory healthcare worker and comprising an overview of tasks of said different healthcare workers including said task for performance by said particular healthcare worker.

12. A system according to claim 11, including
said individual message indicates said particular healthcare worker requests assistance comprising at least one of, (a) a second opinion from said supervisory healthcare worker and (b) communication with said supervisory healthcare worker.

13. A medical information alerting system for use in a system employing portable processing devices, comprising:
an alert processor for generating at least one message to a user of a portable device, said at least one message identifying,
a task to be performed for a patient by a particular user,
patient specific information including a patient location and patient identifier and
a priority level of said task;
a repository of data for use in establishing bidirectional communication with a plurality of portable processing devices assigned to a corresponding plurality of different users; and
a communication processor for using said repository in initiating communication of said at least one message to a portable processing device of said particular user in response to a received command.

14. A system according to claim 13, including
an information management processor for updating a task schedule of said particular user to indicate said task to be performed for said patient by said particular user.

15. A system according to claim 13, including
a repository of data identifying an alternative user to said particular user, said alternative user being designated to perform said task in the event said particular user fails to acknowledge a task assignment message within a predetermined time period and wherein
said communication processor automatically initiates communication of at least one message assigning said task to said alternative user in the event said particular user fails to acknowledge said task assignment message.

16. A system according to claim 13, wherein
said message to said portable processing device of said particular user initiates generation of an audible sound on said portable processing device identifying a high priority level task.

17. A system according to claim 13, wherein
said alert processor generates said at least one message to said user to include information items determined in response to predetermined role dependent information requirements in a user profile.

18. A method for managing medical information using a portable processing device, comprising the activities of:
receiving messages from one or more different healthcare workers, an individual message identifying,
a task for performance by a particular healthcare worker for a patient,
patient and task associated context information and
a priority level of said task;
providing data representing at least one display image for display to a user and comprising an overview of tasks of said different healthcare workers including said task for performance by said particular healthcare worker.
